(19) United States
(12) Patent Application Publication
(10) Pub. No.: US 2011/0259799 A1
(43) Pub. Date: Oct. 27, 2011

(54) CAM-BASED CLASSIFIER FOR THE TREATMENT OF HETEROGENEOUS MASSES OF MATERIALS

(75) Inventor: Fabio Paron, Galliate (Novara) (IT)

(73) Assignee: Globus S.r.I, Galliate (IT)

(21) Appl. No.: 12/998,527

(22) PCT Filed: Oct. 30, 2008
(86) PCT No.: PCT/IB2008/002988

§ 371 Date: Jul. 6, 2011

(51) Int. Cl. B07B 1/14

(52) U.S. Cl. 209/363

(57) ABSTRACT

A cam-based classifier for the treatment of heterogeneous masses of materials comprising a series of rotating elements (15) phase driven around a rotation axis (16) for identifying calibrated passage clearances (17) of a screening plane (14), wherein each of the rotating elements (15) comprises a series of cam elements (20), i.e. having a profile with a variable radius in each plane with a transversal section with respect to the rotation axis (16), said profile progressively having the same proportions and area varying from a maximum area to a minimum area, the cam elements (20) generating an external surface of the rotating elements (15) consisting of a series of parallel crests and cavities arranged transversally with respect to the rotation axis (16), wherein facing cam elements (20) have complimentary front operating surfaces (21) inclined by an angle of (+/−α) greater than 0° and less than 90° and distanced in a transversal direction with respect to the rotation axis by a constant and predeterminable interspace forming the broken-lined passage clearance (17).

The present invention relates to a cam-based classifier for the treatment of heterogeneous masses of materials.

Heterogeneous masses of materials comprise, for example, wood shavings or chips, fibres or other material having different particle-sizes to be separated.

Separating fractions having different particle-sizes by means of vibrating screens and also various types of rotating disk screens, is known.

The latter devices comprise rolls or shafts with disks, i.e. circular elements, rotating in the same direction around their own axis, which form a plane on which the heterogeneous mass to be screened is fed and moved forwards during the separation operations. The disks define interspaces, or clearances, having pre-established dimensions for the selective separation of a portion of material. The passage clearances are defined between facing surfaces formed by the flat flanks of the disks or the outer perimetric surfaces.

The main drawbacks of these devices relate to the wear of the disks, due to friction both on the part of the rough material which is moved forward on the bed and also on the part of the fine material which passes through the interspaces, in addition to the screening efficiency.

The efficiency depends on the capacity of best distributing the heterogeneous material on the plane in both a transversal and longitudinal direction, i.e. in the advance direction of the material, to separate the portion of finer material rapidly and with the maximum precision.

The length of the plane must therefore be sufficient for obtaining the complete separation of the preselected portion of heterogeneous material, planes with considerable lengths, however, obviously involve high encumbrances which are often not compatible with the space available.

An incomplete separation of the preselected portion of heterogeneous material, on the other hand, leads to a low-quality end-product and often problems in the management and maintenance of the stations downstream of the separation device.

Machines for the classification, screening and separation of heterogeneous masses of materials are also known, such as that described in Italian patent application MI2004A001008, in which the screening bed comprises a succession of rotating elements having a transversal section with a cam profile, i.e. with a varying radius, arranged parallel to each other. Adjacent rotating elements are phased and distanced between each other by an adjustable quantity, which creates the passage clearance between the rotating elements, i.e. the screening dimension between the outer facing surfaces.

Thanks to the cam profile, which has a peripheral speed with a sinusoidal profile, the rotating elements transmit a good agitation to the material to be screened, which ensures a better distribution on the screening plane and therefore a better efficiency.

The passage clearances for the material to be screened are formed in the screening plane by a series of straight fissures having a length equal to the length of the rotating elements themselves and a width equal to the distance between their facing surfaces. In height, the fissure extends without obstacles below the screening plane. Consequently, when it is inserted in the fissure in the screening plane, the screened material falls by gravity below to the screening bed without encountering further hindrances.

Consequently, if we imagine a three-dimensional element to be screened, the machine described is particularly effective for screening the material on the basis of the width, but it is deficient in terms of screening with respect to the length and height. This means that a thin sheet of material, but with a relatively large bidimensional extension, or a particle having an elongated shape, are not efficiently withheld by the screening plane even in the presence of small interspaces between the rotating elements. If the particles are positioned close to the passage clearances, parallel to these, they will in fact succeed in passing through the screening plane.

Furthermore, in the machines described above, the screening area is a rigid parameter which cannot be regulated by the user, as it is given by the length of the rotating elements and the width of the fissure which must be regulated in relation to the dimensions of the material to be screened. For high flow-rates of material to be screened which require an increase in the screening area, it is consequently necessary to prolong the length of the screening plane.

An objective of the present invention is to provide a cam-based classifier for the treatment of heterogeneous masses of materials which overcomes the technical drawbacks mentioned above.

A further objective of the present invention is to provide a cam-based classifier for the treatment of heterogeneous masses of materials with an easily adjustable screening dimension.

Another objective of the present invention is to provide a cam-based classifier for the treatment of heterogeneous masses of materials, which is particularly simple and functional, with reduced costs.

These objectives according to the present invention are achieved by providing a cam-based classifier for the treatment of heterogeneous masses of materials as specified in claim 1.

Further characteristics are indicated in the dependent claims.

The characteristics and advantages of a cam-based classifier for the treatment of heterogeneous masses of materials according to the present invention will appear more evident from the following illustrative and non-limiting description, referring to the enclosed schematic drawings, in which:

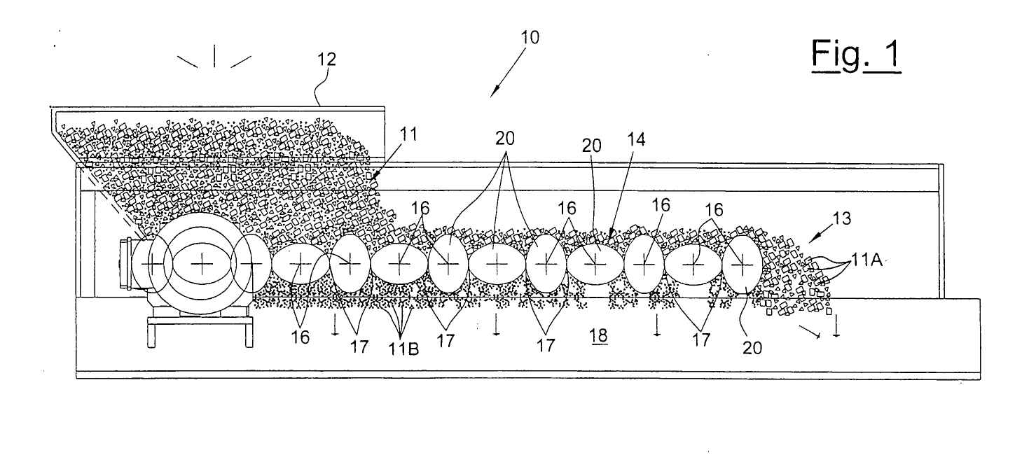

FIG. 1 is a raised schematic side view in partial cross-section of a cam-based classifier for the treatment of heterogeneous masses of materials according to the present invention;

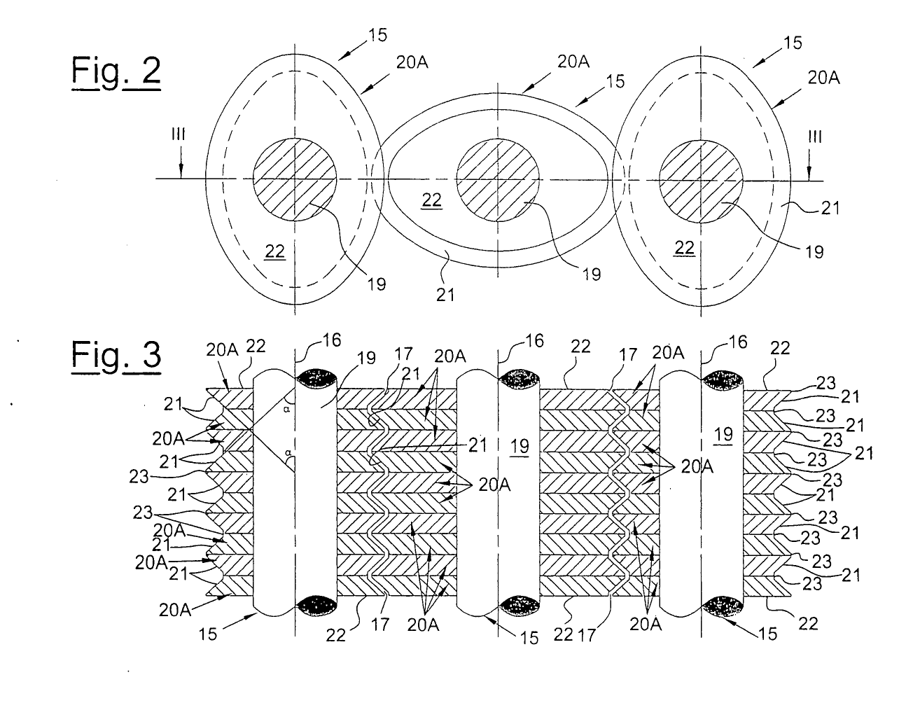

FIG. 2 is a raised side view of a portion of the screening plane comprising three shafts carrying cam elements according to a first elliptic embodiment;

FIG. 3 is a sectional view according to the trace III-III of FIG. 2;

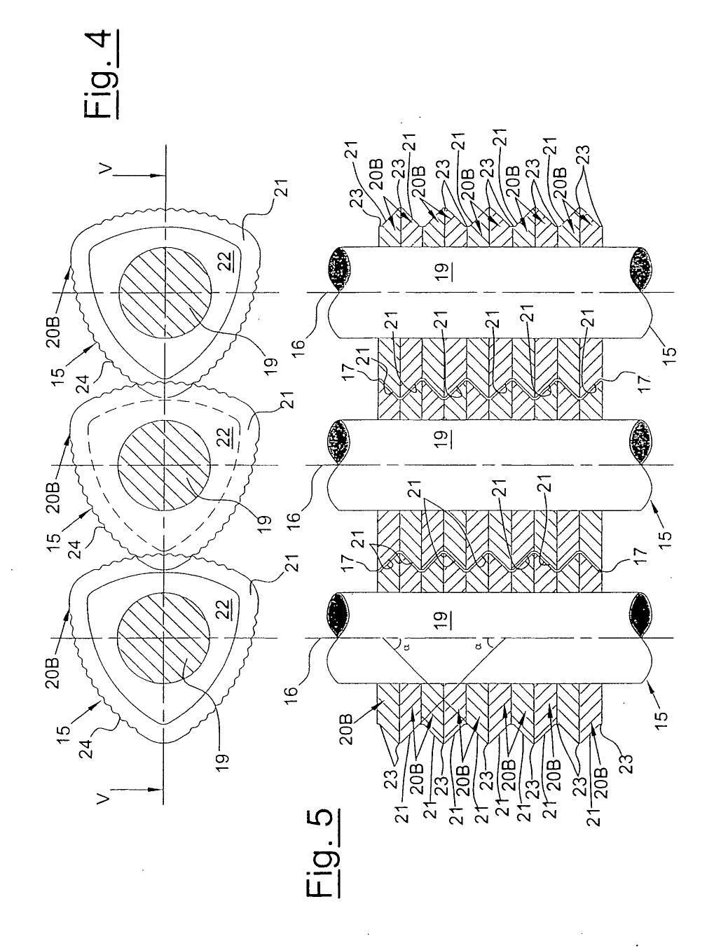

FIG. 4 is a raised side view of a portion of the screening plane comprising three shafts carrying cam elements according to a second trilobate embodiment;

FIG. 5 is a sectional view according to the trace V-V of FIG. 4;

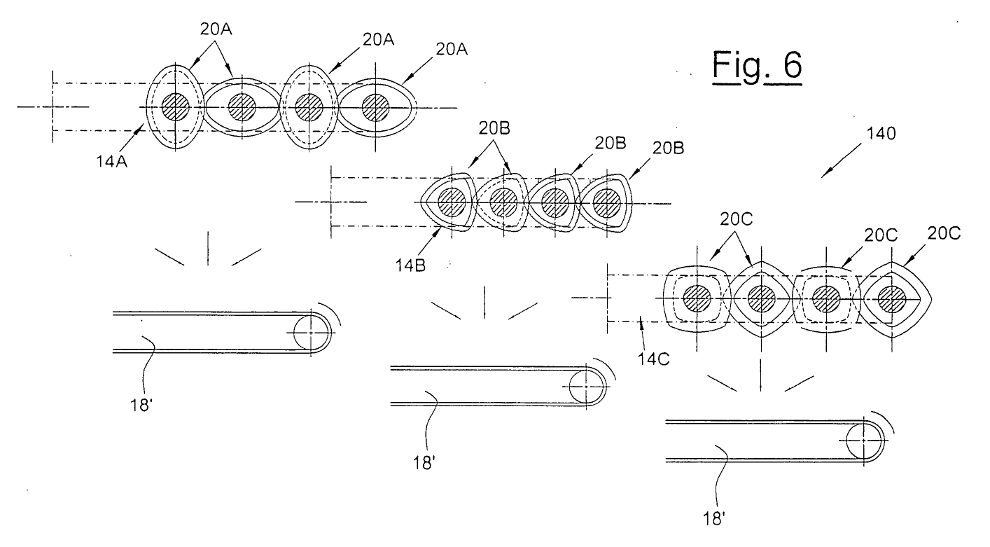

FIG. 6 is a raised schematic view of a screening plane divided into three branches with different heights;

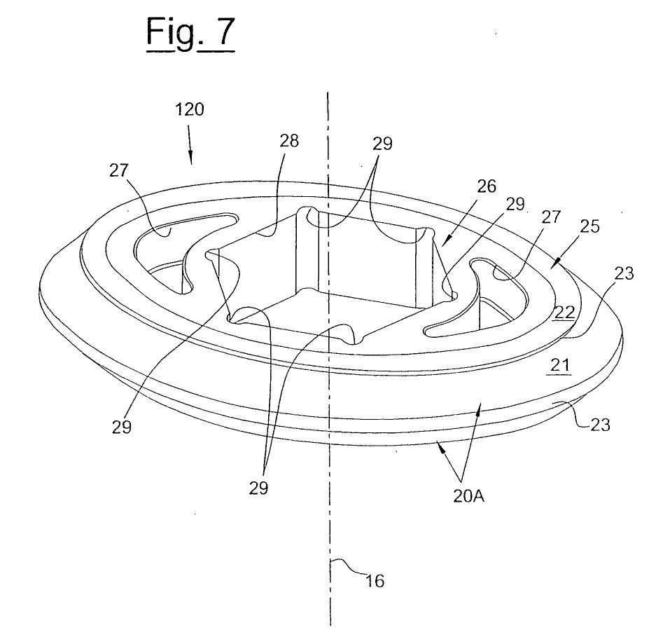

FIG. 7 shows an enlarged detail of a composite cam element according to a further embodiment of the present invention.

With reference to FIG. 1, this shows a cam-based classifier for the treatment of heterogeneous masses of materials indicated as a whole with 10, which comprises a screening plane 14 of heterogeneous masses of materials 11, a feeding area 12 for said heterogeneous masses at a first end of the plane 14 and a discharge 13 of a rough portion 11A of material at an opposite end.

The heterogeneous masses of materials, which are positioned on the screening plane 14 forming a bed, can be either wood-based material in the form of chips, shavings, pellets or fibres, or mineral materials, such as gravel, marble or similar products, or coal or all heterogeneous materials in general which require granulometric or humid separation.

The screening plane 14 comprises a series of rotating elements 15, put in rotation around its own axis 16 by known actuators, not shown.

The rotating elements 15, shown schematically in FIG. 1, are arranged parallel to each other, flanked and distanced laterally by a predefined degree to form calibrated passage clearances 17 for a portion of material of heterogeneous masses to be classified, with a pre-established form and dimensions 11B.

The portion of separated material 11B is collected beneath the screening plane 14, and fed to subsequent stations, for example by means of collection spaces or collection bed 18′, shown in FIGS. 1 and 6 respectively.

Each rotating element 15 comprises an axial shaft 19 which can be of any form, carrying a series of cam elements 20, i.e. with a varying radius, aligned along the axis 16.

The cam elements 20, sectioned according to any plane transversal to the rotation axis 16, have a cam profile, i.e. with a varying radius, in the section plane. The profiles can therefore have any sectional form and different from circular. FIGS. 2, 3 and 6 show, for example, cam elements with elliptic transversal sections 20A, FIGS. 4, 5 and 6, on the other hand, show cam elements with substantially triangular or trilobate transversal sections 20B. Other possible transversal sections for a classifier according to the present invention could have a substantially square or quatrefoil form 20C, as shown in FIG. 6, or other forms.

The transversal sections of each cam element 20, obtained according to parallel planes and different to each other, do not have the same dimensions, but vary from a maximum area to a minimum area, reached in correspondence with opposite flat side surfaces, or flanks, 22, respectively. The same proportions are maintained, however, with varying areas, as shown in FIGS. 2 and 4.

Each cam element 20 consequently comprises a front operating surface 21 which is not parallel to the rotation axis 16 but inciding with respect to the same axis in one point. In each section plane passing through the rotation axis 16, in fact, as shown in FIGS. 3 and 5, the front operating surface 21 forms an angle +/−α with the rotation axis 16.

The cam elements 20 are fitted onto the same shaft 19 so that each cam element 20 has its own flanks 22 buffered against or integral with the flanks 22 with dimensions corresponding to the adjacent cam element 20.

An outer surface of the serrated rotating elements 15 is formed, i.e. consisting of a series of parallel crests and cavities arranged transversally with respect to the rotation axis 16.

According to what is shown in FIGS. 3 and 5, the crests and cavities are rounded 23 on the top and bottom to avoid sharp edges.

Along the screening plane 14, each cam element 20 has its front surface 21 facing and collaborating with the complementary front surface 21 of the corresponding cam elements fitted onto the adjacent shafts 19 and laterally distanced by a constant and predetermined unit to form a broken-lined passage clearance 17.

The passage area of the material to be classified substantially depends on the profile of the complementary front surfaces 21 of the facing cam elements 20 and on a transversal interspace between the same.

According to the present invention, the passage clearance 17 between two collaborating rotating elements forms a broken line in the screening plane corresponding to the trend of the crests and cavities of the rotating elements 15.

The broken-line trend allows the maximum length of the particles to be classified to be controlled, which coincides with the length of the front operating wall 21 of the cam elements 20.

A broken passage clearance, with the same length of the rotating elements, causes an increase in the passage area for the material to be classified with respect to a straight passage clearance. The increase in the passage area is proportional to the increase in the total length of the passage clearance, a parameter which can be influenced by the angulation that the operating surfaces 21 of the cam elements 20 have with respect to the rotation axis 16. When the α angle is 45°, for example, as shown in FIGS. 3 and 5, the increase in the length of the passage clearance 17 is equal to a factor of 1.41. Consequently, for angles α>45°, i.e. sharper crests, the increase in the passage clearance is greater, whereas for angles α<45°, i.e. flatter crests, the increase in the passage clearance is lesser. The angle α, which must be greater than 0° and less than 90° to create the crests and cavities, is generally within a range of 15° to 75°.

In order to increase the passage clearance, it is obviously possible to act on the interspace between the facing cam elements 20, by moving the respective shafts 19 away.

The profile of the front operating surfaces 21 thus composed is capable of developing a peripheral speed of the sinusoidal type of the rotating elements 15 all phase driven.

Due to the dynamic action of the cams, the particles having larger dimensions and/or with a greater weight, jump more than those having smaller dimensions, i.e. they acquire a greater kinetic energy, favouring the separation of the portion of rough material from the fine material.

In the cam classifier 10 according to the present invention, it has been observed that the presence of crests, combined with the sinusoidal speed profile of the cam elements 20, causes the remixing of a significant layer of the bed of material.

Furthermore, with an effect similar to that of a plough, the rougher parts of the heterogeneous mass tend to tilt on one side shaking off the smaller particles which are therefore separated from the first portion of the screening plane from the rough portion, without being entrained thereby.

FIG. 1 shows, for illustrative purposes, a screening plane 14 having a constant passage clearance between the rotating elements over the whole of its length. The material is therefore classified into two portions only, the portion 11B having dimensions smaller than the passage clearances and the portion 11A having larger dimensions, but still heterogeneous. It is evident that a classifier according to the present invention can comprise a series of screening branches situated in succession and having different passage clearances 16, with increasing dimensions, to separate homogeneous masses of material having progressively increasing dimensions.

A cam-based classifier for the treatment of heterogeneous masses of material 10, according to the present invention, can comprise successive branches which also differ from each other in other characteristics such as form, dimensions and rotation speed of the cam elements for classifying different types of material contained inside the heterogeneous mass of material, according to optimum efficiency parameters.

FIG. 6 schematically shows a screening plane 140 divided into three successive screening branches 14A, 14B, 14C situated at different heights and having independent characteristics, each provided with a bed 18′ for the collection and discharging of the material classified.

In the example illustrated, a first branch 14A consists of elliptic cam elements 20A which, due to their profile speed, give the heterogeneous mass a considerable kinetic agitation which causes an immediate stratification of the material and the separation of the fine portion from the rough portion which jumps forward. A second branch 14B consists of trilobate cam elements 20B, which transmit a lower level of kinetic energy causing a mixing of the heterogeneous mass to favour the classification of the chips. A last branch 14C comprises quatrefoil cam elements 20C, which transmit even less kinetic energy for moving the so-called oversize material forward, which has larger dimensions with respect to chips.

What is shown and described is an example among the many possible combinations which can be found for each specific type of heterogeneous material to be treated.

According to what is known, the screening plane 14, as also each of the single branches 14A, 14B, 14C of the screening plane 140, can be tiltable with respect to a horizontal plane.

The heterogeneous material 11 can be moved forward at a greater or lesser speed by regulating the rotation speed of the rotating elements 15 and tilting the screening plane 14 differently, also for the purpose of separating pollutants, such as, for example, sand mixed with particles of wood, or due to the greater or lesser humidity of the product to be classified. By exploiting the kinetic energy, the cam elements can in fact exceed tilting angles, for example up to over 20°, which is not possible for traditional screens equipped with cylindrical elements.

The cam elements 20 can be individually fitted onto the shaft or they can be equivalently produced in a single piece as also in groups of two or more cam elements.

For illustrative and non-limiting purposes, FIGS. 3 and 5 show cam elements 20 individually fitted onto the shaft. FIG. 7 shows two cam elements, in the elliptic example, produced integral with each other.

The cam elements 20 can also have any type of engravings 24 on their operating surfaces 21, and also on the crests, forming variably shaped reliefs, in the form of pyramids, prisms, parallelepipeds, with a radial or helicoidal trend, having a fixed or varying geometry, etc. as shown for example in FIG. 4.

FIG. 7, according to a further embodiment of the present invention, shows a composite cam element 120 made of a synthetic material.

The composite cam element 120 is illustrated for illustrative purposes with an elliptical form and comprising two integral cam elements, but it can have any other form, other than a cylindrical form. The composite cam element comprises an outer annular portion 25 made of a first polymeric material and a central portion 26 made of a different polymeric material.

The outer annular portion 25 is made of a polymer containing substances which increase its resistance to wear and which allow the elastic yielding of the outer surface to a predetermined compression value. A polymeric resin can be used for example, based on polyamide and comprising 30% by weight of reinforced glass fibres, thermostabilized and resistant to hydrolysis.

This category of material is in fact marked by a good mechanical resistance to wear and deformation, in addition to a good surface resistance.

The central portion 26 is made of a polymer containing substances which increase its mechanical resistance. Thermoplastic polyurethanes can be used, for example, based on polyester and polyether, or based on modified polyesters. These materials in fact have a high elasticity.

The central part 26 and the annular part 25 are obtained by overmoulding.

The central part 26 is equipped with moulding cavities 27 to prevent shrinkage and an axial hole 28 for fitting onto the shaft 19. The axial hole 28, hexagonal for example, has jointed edges 29 to avoid assembly interferences.

The production of composite cam elements 120 in a synthetic material advantageously reduces the production and maintenance costs.

Furthermore, the yield characteristic of the material of the annular part prevents the blocking of the machine. In traditional metallic screens in fact, it may happen that a particle having dimensions approximate to the interspace between the metallic rolls becomes stuck between them.

The yielding of the surface of the cam elements made of synthetic material, upon reaching a certain compression, on the other hand, allows the passage of these particles eliminating the wear that would be caused by friction.

The cam-based classifier for the treatment of heterogeneous masses of materials, object of the present invention, has the advantage of having an excellent efficiency, even four times greater with respect to traditional machines, i.e. it is capable of classifying high flow-rates of heterogeneous material on reduced lengths of the screening plane.

In particular, the efficiency in terms of flow-rate that can be handled on a certain length, surprisingly increases more than proportionally with respect to the increase in the passage area.

The classifier according to the present invention allows numerous regulations to be effected for adapting itself to different requirements in terms, for example, of flow-rate, velocity and the type of material to be screened.

Furthermore, it advantageously effects a classification of the particles of the heterogeneous mass according to all three spatial dimensions.

The classifier according to the present invention also has an excellent resistance to wear as the material is moved forward by kinetic energy transmitted rather than by friction.

The cam-based classifier for the treatment of heterogeneous masses of materials according to the present invention is also advantageously suitable for treating heterogeneous masses containing filamentous materials. The non-constant peripheral speed profile of the cam elements, in fact, does not favour the formation of a ball, which, on the other hand, would require a constant speed.

The cam-based classifier for the treatment of heterogeneous masses of materials thus conceived can undergo numerous modifications and variants, all included in the invention; furthermore, all the details can be substituted by technically equivalent elements. In practice, the materials used, as also the dimensions, can vary according to technical requirements.

1. A cam-based classifier for the treatment of heterogeneous masses of materials comprising a series of rotating elements (15) phase driven around a rotation axis (16) and arranged parallel and flanked along a screening plane (14) for identifying calibrated passage clearances (17) for a portion of material (11B) having a pre-established form and dimensions of said heterogeneous masses (11), characterized in that each of said rotating elements (15) comprises a series of cam elements (20), i.e. having a profile with a variable radius in each plane with a transversal section with respect to said rotation axis (16), said profile progressively having the same proportions and area varying from a maximum area to a minimum area, said cam elements (20) being aligned together along a shaft (19) on the respective side surfaces (22) having corresponding dimensions, generating an external surface of said rotating elements (15) consisting of a series of parallel crests and cavities arranged transversally with respect to said rotation axis (16), wherein facing cam elements (20) belonging to adjacent rotating elements (15) have complimentary front operating surfaces (21), inclined by an angle of (+/−α) greater than 0° and less than 90° and distanced in a transversal direction with respect to the rotation axis by a constant and predeterminable interspace forming said broken-lined passage clearance (17).

2. The classifier according to claim 1, characterized in that said front surfaces (21) of said cam elements (20) incide with said rotation axis (16) of said angle (α) varying from 15° to 75°, forming crests with an increasing height.

3. The classifier according to claim 1, characterized in that said crests and said cavities are rounded (23) at the top and bottom.

4. The classifier according to claim 1, characterized in that said cam elements (20) have an elliptic (20A), trilobate (20B) or quatrefoil (20C) transversal section.

5. The classifier according to claim 1, characterized in that said front operating surfaces (21) of said cam elements (20) are smooth flat surfaces.

6. The classifier according to claim 1, characterized in that said front operating surfaces (21) of said cam elements (20) have engravings (24) with a fixed or varying geometry.

7. The classifier according to claim 1, characterized in that said cam elements (20) of a rotating element (15) are individually fitted onto a shaft (19).

8. The classifier according to claim 1, characterized in that said cam elements (20) of a rotating element (15) are produced in a single piece fitted onto a shaft (19).

9. The classifier according to claim 1, characterized in that said cam elements (20) of a rotating element (15) are produced in groups of two or more cam elements (20) fitted onto a shaft (19).

10. The classifier according to claim 1, characterized in that said screening plane (14) comprises at least two branches (14A, 14B, 14C) at different heights.

11. The classifier according to claim 10, characterized in that said at least two branches (14A, 14B, 14C) have independent characteristics with respect to each other.

12. The classifier according to claim 1, characterized in that said cam elements (20) are made of a synthetic material.

13. The classifier according to claim 12, characterized in that said cam elements (20) comprise an outer annular portion (25) made of a first polymeric material and a central portion (26) made of a second polymeric material.

14. The classifier according to claim 13, characterized in that said first polymeric material comprises additive substances which increase its resistance to wear and allow the elastic yield of said front operating surface to a predetermined compression value.

15. The classifier according to claim 13, characterized in that said first polymeric material containing additive substances is a polymeric resin based on polyamide and comprising 30% by weight of reinforced glass fibres, thermostabilized and resistant to hydrolysis.

16. The classifier according to claim 13, characterized in that said second polymeric material comprises additive substances which increases its mechanical resistance.

17. The classifier according to claim 13, characterized in that said second polymeric material containing additive substances is a thermoplastic polyurethane based on polyester, polyether or modified polyesters.

18. A composite cam element (120) for a classifier according to claim 1, characterized in that it comprises an outer annular portion (25) comprising at least one cam element (20) made of a first polymeric material containing additive substances and a central portion (26) for fitting onto a shaft (19) made of a second polymeric material containing additive substances.

19. The composite cam element according to claim 18, characterized in that said first polymeric material containing additive substances is a polymeric resin based on polyamide and comprising 30% by weight of reinforced glass fibres, thermostabilized and resistant to hydrolysis.

20. The composite cam element according to claim 18, characterized in that said second polymeric material containing additive substances is a thermoplastic polyurethane based on polyester, polyether or modified polyesters.
